(19) United States
(12) Patent Application Publication
(10) Pub. No.: US 2026/0079682 A1
(43) Pub. Date: Mar. 19, 2026

(54) AUTOMATING SERVICE OPTIMIZATION TASKS USING EXTENSIBLE FLEETS OF GENERATIVE ARTIFICIAL INTELLIGENCE AGENTS

(71) Applicant: Amazon Technologies, Inc., Seattle, WA (US)

(72) Inventors: Chuandong Zhou, Westminster, CO (US); Pramod Varma, Boulder, CO (US)

(73) Assignee: Amazon Technologies, Inc., Seattle, WA (US)

(21) Appl. No.: 18/890,662

(22) Filed: Sep. 19, 2024

(51) Int. Cl. G06F 8/41; G06F 8/73

(52) U.S. Cl. CPC G06F 8/443; G06F 8/73

(57) ABSTRACT

Corresponding to individual ones of a plurality of categories of optimization tasks of a service, respective generative artificial intelligence models (GAIMs) are configured. A prompt which instructs a first GAIM to identify a candidate optimization task of a particular category is presented to the first GAIM. The candidate optimization task, identified by the first GAIM, is then initiated using another GAIM.

### BACKGROUND

Many modern services, including various types of content presentation services, are implemented using complex combinations of resources and tools. Domain-specific knowledge about the way the services work is sometimes stored in large natural language knowledge bases which may be hard for non-experts to fully comprehend, or in data stores using schemas that are not necessarily straightforward to understand. Acquiring sufficient fluency with the resources and tools to perform tasks needed to optimize and grow the services, such as enhancing end user engagement levels, can present a non-trivial technical challenge.

### BRIEF DESCRIPTION OF DRAWINGS

FIG. 1 illustrates an example system environment in which generative artificial intelligence (GAI) based agents of a network-accessible optimization automation service may be used to propose and perform a variety of optimization tasks pertaining to target services and applications, according to at least some embodiments.

FIG. 2 illustrates a high level overview of an example continuous workflow for proposing and executing optimization tasks using multiple extensible fleets of GAI agents, according to at least some embodiments.

FIG. 3 illustrates example aspects of a workflow for generating proposed optimization tasks, according to at least some embodiments.

FIG. 4 illustrates an example web-based interface which may be used to present proposed optimization tasks for programmatic approval, according to at least some embodiments.

FIG. 5 illustrates aspects of a workflow for automated execution of an optimization task using a pipeline of GAI agents, according to at least some embodiments.

FIG. 6 illustrates example programmatic interactions between clients and an optimization automation service, according to at least some embodiments.

FIG. 7 is a flow diagram illustrating aspects of operations pertaining to automation of optimization tasks using GAI agent fleets, according to at least some embodiments.

FIG. 8 illustrates an example provider network at which an optimization automation service may be implemented, according to at least some embodiments.

FIG. 9 illustrates example categories of optimization tasks which may be performed for one or more target services by an optimization automation service, according to at least some embodiments.

FIG. 10 is a block diagram illustrating an example computing device that may be used in at least some embodiments.

While embodiments are described herein by way of example for several embodiments and illustrative drawings, those skilled in the art will recognize that embodiments are not limited to the embodiments or drawings described. It should be understood that the drawings and detailed description thereto are not intended to limit embodiments to the particular form disclosed, but on the contrary, the intention is to cover all modifications, equivalents and alternatives falling within the spirit and scope as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to. When used in the claims, the term “or” is used as an inclusive or and not as an exclusive or. For example, the phrase “at least one of x, y, or z” means any one of x, y, and z, as well as any combination thereof. Unless otherwise explicitly stated, articles such as “a” or “an” should generally be interpreted to include one or more described items throughout this application. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C. Unless otherwise explicitly stated, the terms “set” and “collection” should generally be interpreted to include one or more described items throughout this application. Accordingly, phrases such as “a set of devices configured to” or “a collection of devices configured to” are intended to include one or more recited devices. Such one or more recited devices can also be collectively configured to carry out the stated recitations. For example, “a set of servers configured to carry out recitations A, B and C” can include a first server configured to carry out recitation A working in conjunction with a second server configured to carry out recitations B and C.

### DETAILED DESCRIPTION

The present disclosure relates to methods and apparatus for using extensible fleets of agents that comprise generative artificial intelligence models (GAIMs) to automate various types of tasks for optimization of complex services and applications. The optimization tasks may include, for example, enhancing user engagement levels with a content presentation service or an online store by defining new end user segments, identifying or generating/synthesizing new secondary or supplemental content for presentation to end users, and so on. The services or applications (including but not limited to content presentation services, travel services, online food ordering services, online store management services, financial services, insurance services and the like) for which optimization tasks are automated using the agent fleets may be referred to as target services or optimization targets herein.

At a high level, the techniques introduced herein may comprise configuring and utilizing at least two fleets of GAI agents in an ongoing continuous workflow. A given GAI agent may, for example, comprise software that autonomously provides custom prompts as input to one or more GAIMs based on triggering conditions, retrieves auxiliary data from data sources representing long term or short term memory of the GAIMs if needed, and distributes results of the GAIMs to appropriate recipients/destinations to accomplish an objective (such as the generation and presentation of candidate optimization tasks for a target service) for which the GAI agent was established. A first fleet of GAI agents may examine, at various points of time, large diverse sets of dynamically updated target service related information including data sources with entries (such as knowledge base articles or entries) expressed in natural language as well as records of optimization tasks initiated earlier, and automatically propose new optimization tasks based on unbiased analysis of the information. A second fleet of GAI agents may implement approved proposed tasks, e.g., by invoking tools and APIs (application programming interfaces) associated with the target services after determining how best to translate natural language descriptions of the approved tasks to lower-level executable operations. The implemented tasks may lead to changes at the resources and artifacts of the target services, with at least some of the changes impacting end users. Based at least in part on the changes, the target service related information accessible to the first fleet of GAI agents may also be updated, which may in turn trigger subsequent generation of proposed optimization tasks by the first fleet of GAI agents. As a result, the operations of a given target service may be automatically improved continually over time, enabling the objectives of the service provider to be achieved much faster and more efficiently than if the fleets of GAI agents were not deployed.

As and when new categories of tasks are identified for various target services, new GAI agents for proposing examples of such tasks may be added to one or both fleets in various embodiments, making the system highly extensible. If at some point a target service owner determines that a particular category of task is no longer a good fit, the corresponding GAI agents may be disabled. Target service owners may also make decisions about resources allocated to the agents, adjust the rates at which the GAI agents or their GAIMs are executed, and so on.

In various embodiments, fleets of GAI agents for proposing and performing optimization tasks for various target services may be set up at the request of target service owners by a network-accessible optimization automation service (OAS) of a cloud computing environment or cloud provider network. In some embodiments, the OAS may implement programmatic interfaces that can be used by target service owners or administrators that wish to set up GAI agent fleets. The target service owners may use the programmatic interfaces to provide various details of their requirements for optimization tasks, obtain metrics pertaining to their services'use of the agents, and so on. Various aspects of the deployment and execution of GAI agents and/or associated GAIMs may be controlled via the programmatic interfaces by the target service owners in some embodiments, such as the triggering conditions for initiating invocations of GAIMs of task proposal agents, triggering conditions for presentation of proposed optimization tasks to end users authorized to approve/reject the proposed tasks, and so on. In addition, in at least one embodiment, the OAS may also implement programmatic interfaces which can be used to present candidate proposed optimization tasks to a set of end users to whom the needed permissions have been granted by target service owners, obtain approvals (or rejections) from such end users for various proposed optimization tasks, and/or provide metrics indicative of the impact of implementation of approved optimization tasks.

The term “generative artificial intelligence model” (GAIM) generally refers to large neural network-based machine learning (ML) models that are trained initially (in a process often referred to as pre-training) using enormous amounts of data such as millions of text sentence examples, such that the resulting model learns enough about the input to be relatively easily adapted for many different downstream tasks including generating completions for text sequences or synthesizing new content. The models may be referred to as “large” because of the number of parameters or weights that they each comprise (e.g., millions or billions of parameters). In some cases, GAIMs may be referred to as “foundation” models, because they can provide a foundation for performing many different kinds of inference or prediction tasks. LLMs, typically pre-trained using natural language inputs, are an important type of GAIM, and are used for a variety of applications including summarization, question-answering chatbots, classification and the like. A multi-modal language model (MMLM) may comprise a machine learning model which has been trained using input comprising not just text examples, but also examples comprising content of several modalities such as images, videos, audio and the like, enabling the model to provider inferences pertaining to such mixed-modality inputs. Pre-training of GAIMs may often use unsupervised, self-supervised or semi-supervised training techniques. A pre-trained GAIM may be fine-tuned (e.g., using a relatively small set of labeled examples) for specific use cases and specific problem domains in some cases, although the pre-trained version of an GAIM may itself be able to perform high-quality inference tasks in many cases.

As one skilled in the art will appreciate in light of this disclosure, certain embodiments may be capable of achieving various advantages, including some or all of the following: (a) enabling new candidate tasks to be automatically identified and proposed, in easy-to-understand natural language, for optimizing or enhancing the effectiveness of various kinds of target services with respect to achieving business objectives of the service owners, with individual ones of the candidate tasks being identified based on analysis of large amounts of dynamically changing information, (b) providing reasons or explanations for the selection of the candidate tasks, thereby increasing end user confidence in the methodology being used to generate the candidate tasks, and (c) in response to detecting that a candidate optimization task has been approved, automatically translating the natural language representation of the tasks into computer-executable lower-level operations and causing the lower-level operations to be performed while consuming the minimum amount of computing and other resources. In at least some embodiments, one of the benefits of using the proposed techniques to automatically generate candidate tasks is the elimination of certain kinds of biases which may occur if individuals rather than GAIMs were tasked with identifying the candidate tasks—e.g., humans may tend to select tasks based on familiarity with the individuals who initiated similar tasks, or familiarity with the components of the system which are used for similar tasks, rather than on the benefits that were actually obtained as a result of performing the tasks.

According to some embodiments, a system may include one or more computing devices. The computing devices may include instructions that upon execution on or across the one or more computing devices identify, at an optimization automation service (OAS) of a cloud computing environment, (a) a plurality of user engagement optimization task categories of a target service and (b) a plurality of dynamically updated data sources associated with, and comprising information related to, the target service. At least some of the data sources may comprise documentation (e.g., knowledge base articles/entries, optimization task descriptions with indications of expected/measured benefits of the tasks, user documentation such as user guides of the target service, records indicating or discussing trends of various metrics of the target service including user engagement metrics, etc.) in unstructured natural language. Some of the data sources may comprise records of earlier-completed optimization tasks of one or more of the categories, indicating when the tasks were performed and at whose request, metrics which changed as a result of performing the tasks, and so on. In some embodiments, the data sources may comprise records of optimization tasks which were rejected by users of the OAS, indicating when the tasks were rejected, by whom, and whether any other candidate tasks which were presented to an end user concurrently with the rejected tasks were approved by the end user.

Subsequent to identification of the task categories, (a) respective task proposer agents (TPAs) and (b) respective task implementer agents (TIAs) corresponding to individual ones of the task categories may be configured at a machine learning service of the cloud computing environment in some embodiments. Individual ones of the TPAs may comprise or use a respective LLM or GAIM in various embodiments. Similarly, in at least sone embodiments, individual ones of the TIAs may comprise or use a respective LLM or GAIM.

In at least some embodiments, in response to detection of a triggering condition, a prompt may be presented to an LLM of a first TPA, without receiving a request from an end user of the OAS to invoke the first TPA or its LLM. The prompt may instruct the LLM to, based at least in part on analysis of content of one or more of the data sources, identify a proposed or candidate optimization task of a particular user engagement optimization task category in various embodiments. The prompt may be customized for a particular set of end users in some embodiments—e.g., it may instruct the LLM to access private data that cannot be utilized for tasks executed on behalf of end users that are members of the particular set of end users. Any of a variety of triggering conditions may lead to the presentation of the prompt, such as a determination that content of the one or more data sources has changed since a previous analysis, a determination that a specified amount of time has elapsed since a previous analysis performed on behalf of a set of end users, and so on. In at least one embodiment, an analysis of some of the data sources may reveal the set of candidate tasks that were approved and/or rejected earlier by one or more end users, enabling the TPA to identify a new candidate optimization task (i.e., one that has not recently been performed or rejected) for presentation to an end user.

In response to detection of another triggering condition, a natural language representation of the candidate optimization task may be presented via one or more programmatic interfaces to a particular end user of the OAS in various embodiments. This second triggering condition may, for example, comprise determining that the end user has logged in for the first time during a specified time interval, that a specified amount of time has passed since an earlier proposed optimization task was presented to the end user, and so on. In at least one embodiment, in addition to a description of the task itself, an indication of one or more reasons or justifications for proposing or presentation of the task may also be provided via the interfaces. In response to obtaining approval of the candidate optimization task via the programmatic interfaces, a TIA may be caused to initiate the candidate optimization task in various embodiments. In at least one embodiment, after the candidate task has been initiated or completed, an indication of a change in a metric of the target service (which may have been caused by the candidate task) may be presented to the end user via programmatic interfaces. Such metrics may for example include the number of times content proposed in an optimization task has been viewed by end users of the target service, a number of target service interactions initiated by end users of a particular end user segment after a task associated with the end user segment was performed, and so on.

In at least some embodiments, one or more of the optimization task categories for a particular target service, and/or the associated data sources from which information about the target service can be obtained, may be indicated to the OAS via programmatic interfaces by the owner of the service. In one embodiment, triggering conditions for initiating analysis of the data sources, and/or triggering conditions for presenting proposed optimization tasks to end users, may be specified or defined via programmatic interfaces of the OAS. In some embodiments, one or more metrics associated with execution of the TPAs, TIAs, and/or specific GAIMs used by the TPAs/TIAs may be presented to target service owners via programmatic interfaces. Such metrics may, for example, include resource utilization levels of computing resources (e.g., graphics processing unit (GPU)-equipped compute instances of virtualized computing service of a cloud provider network) utilized by the TPAs/TIAs, the number of APIs of various kinds executed by the TIAs, response times between presentation of prompts to the GAIMs of the TPAs/TIAs and generation of corresponding output, and so on. In at least one embodiment, the owner of a target service may indicate, via one or more programmatic interfaces, one or more prompt sources from which custom prompts that are to be provided as input to the GAIMs of the TPAs/TIAs set up for that target service can be obtained. In one embodiment, such prompt sources may comprise a group of prompt engineers associated with the target service.

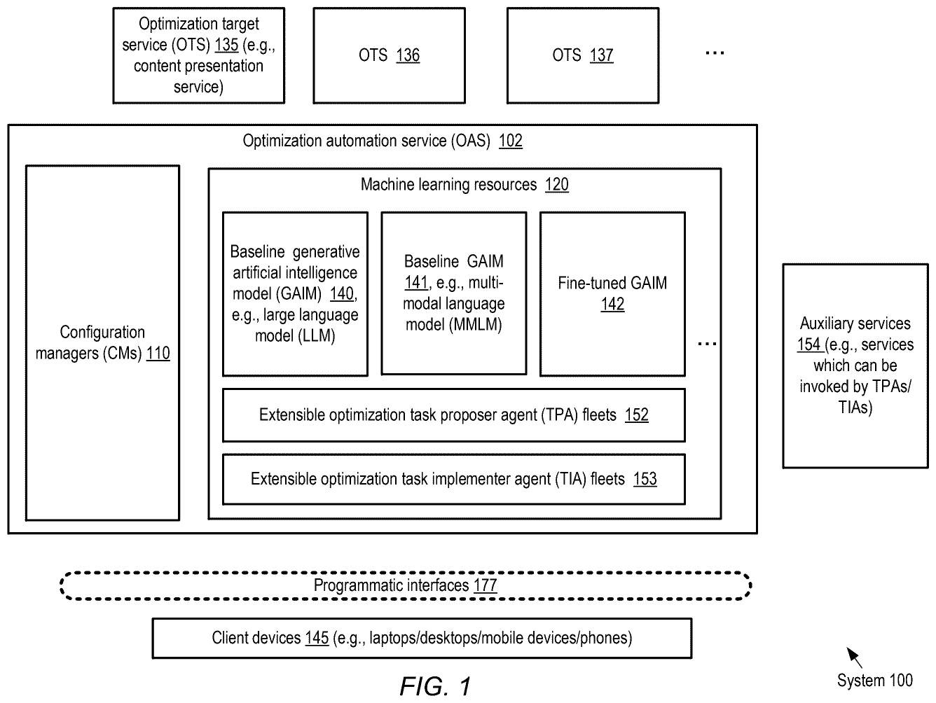

FIG. 1 illustrates an example system environment in which generative artificial intelligence (GAI) based agents of a network-accessible optimization automation service may be used to propose and perform a variety of optimization tasks pertaining to target services and applications, according to at least some embodiments. As shown, system 100 may include resources and artifacts of an optimization automation service (OAS) 102. The OAS may comprise a set of configuration managers (CMs) 110, each comprising some combination of hardware and software of one or more computing devices, and a collection of machine learning resources 120. The machine learning resources may in turn include various kinds of GAIMs, as well extensible fleets of GAI agents in various embodiments.

OAS 102 may implement a set of programmatic interfaces 177 in the depicted embodiment, which may be used by various types of clients to interact with the CMs and/or to interact with GAI agents. Programmatic interfaces 177 may include, among others, a web-based console, command-line tools, application programming interfaces, graphical user interfaces and the like. The programmatic interfaces may be used by at least two types of clients in some embodiments. One set of clients may comprise owners or administrators of optimization target services (OTSs) such as OTS 135, OTS 136 or OTS 137, who wish to deploy fleets of GAI agents to automate the process of optimizing various aspects of the target services. This first set of clients may submit requests from a variety of client devices 145 (such as desktops, laptops, mobile computing devices, phones and the like) via programmatic interfaces 177 to set up agents for various optimization task categories, obtain metrics associated with the execution of the agents, and so on. Another set of clients of the OAS may be provided outputs generated by the GAI agents, such as natural language representations of proposed optimization tasks which these clients can approve or reject, metrics indicating the impact or effects of approved optimization tasks, and so on.

Machine learning resources 120 of OAS 102 may include a set of GAIMs, such as baseline GAIM 140, baseline GAIM 141, fine-tuned GAIM 142, and the like in various embodiments. A GAIM may be referred to as baseline if it has been pre-trained (e.g., using a large corpus of text or multi-modal input documents) but has not been fine tuned in the depicted embodiment. Baseline GAIM 140 may, for example, comprise an LLM, while baseline GAIM 141 may comprise a multi-modal language model (MMLM) which can process input that can include text, images, videos, audio and the like. Fine-tuned GAIM 142 may comprise an GAIM which has undergone two phases of training—a pre-training phase followed by a (typically shorter) fine tuning phase in which a set of input examples pertaining to a particular problem domain is used to further train the pre-trained version of the GAIM for performing specific types of inferences such as generating proposed optimization tasks for a particular OTS. In at least some embodiments, one or more of the GAIMs may be hosted at computing devices (e.g., virtual machines or bare metal instances which include machine learning computation accelerators such as GPUs (graphics processing units)) of a cloud computing environment at which the OAS is also implemented.

In the depicted embodiment, machine learning resources 120 may also comprise extensible optimization task proposer agent (TPA) fleets 152 and extensible optimization task implementer agent (TIA) fleets 153. A given TPA fleet may be configured or established, e.g., at the request of an owner or administrator of a particular OTS to automatically generate candidate optimization tasks of one or more OTS-specific task categories. An individual TPA of the fleet may be configured to provide custom prompts to one or more GAIMs of the OAS based on triggering conditions, with a given custom prompt instructing a GAIM to analyze content of one or more OTS-specific (and/or end user specific) data sources and prepare natural language representations of candidate optimization tasks of a particular OTS-specific category in the depicted embodiment. A given TIA fleet may be configured or established, e.g., at the request of an owner or administrator of a particular OTS to automatically execute optimization tasks of one or more OTS-specific task categories, e.g., in response to determining that the task has been approved by an end user of the OAS. An individual TIA of the fleet may be configured to provide custom prompts to one or more GAIMs of the OAS, with a given custom prompt instructing a GAIM to perform actions such as invoking APIs or tools to perform the optimization task. At a high level, TPAs may be responsible for examining content of OTS-specific data sources and coming up with natural language descriptions of new proposed optimization tasks, while TIAs may translate natural language descriptions of approved optimization tasks into executable actions and then initiate or perform the executable actions in the depicted embodiment.

In at least some embodiments, one or more of the TPAs or TIAs may access auxiliary services 154 to perform their respective actions. For example, an auxiliary service 154 may comprise storage devices at which data pertaining to the OTSs is stored, such as knowledge bases in which natural language descriptions of optimization tasks of various categories, and their respective benefits, are stored. Another auxiliary service 154 may, for example, comprise a database in which records of optimization tasks at an OTS that have already been performed are stored, including the dates/times at which the tasks were initiated or completed, changes to OTS metrics that were measured subsequent to the implementation of the tasks, and so on. Some auxiliary services 154 may initiate transactions at the request of TIAs, such as purchases of new content, modifications of OTS supply chain settings (such as changes to suppliers of one or more products vended via an online store, or changes to transport/delivery options for one or more products) and the like in some embodiments.

In some embodiments, a configuration manager 110 of the OAS may identify one or more user engagement optimization task categories of an OTS (e.g., types of automatable tasks which can be performed to increase the level of engagement of end users with the OTS, such as the amount of time that end users remain logged into a content presentation OTS, or the number of purchases that the end users make at an online store OTS) and a plurality of dynamically updated data sources associated with the OTS. The data sources (some of which may be accessed via auxiliary services 154) may comprise large quantities of unstructured documents in some embodiments, and/or large amounts of structured data. The amount of data that is included in the data sources, and/or the rate at which it grows, may be quite substantial in some embodiments—e.g., gigabytes of natural language entries may be stored in a knowledge base, with some entries added every day, and hundreds of megabytes of new content may be added (e.g., in the form of user interaction records) every hour or every day, making it virtually impossible for human analysts to keep up with the data.

Corresponding to various user engagement optimization task categories, respective TPAs and respective TIAs may be caused to be hosted at a virtualized computing service (VCS) of a cloud computing environment by a configuration manager in various embodiments. In at least one embodiment, a configuration manager 110 may invoke one or more APIs of a machine learning service (MLS) of the cloud computing environment to cause the TPAs and/or TIAs to be hosted at the resources of the VCS.

In various embodiments, a prompt which has been customized for a particular set of end users of an OTS may be presented to a GAIM of a particular TPA in response to a triggering event, for example without receiving a request from any of the end users. The prompt may instruct the GAIM to identify a candidate optimization task of a particular optimization task category for an OTS based at least in part on analysis of content of one or more of the data sources comprising information pertaining to the OTS in some embodiments. In at least one embodiment, respective distinct prompts may be generated and stored at the OAS for multiple optimization task categories and associated TPAs of a given OTS. In some embodiments, the prompts may be created by a team of prompt engineers knowledgeable about the optimization task categories of the OTS, e.g., in response to prompt creation requests submitted by the administrator or owner of the OTS.

In response to such a prompt, the GAIM may analyze content of the data sources and generate a natural language descriptor of one or more candidate optimization tasks for the OTS and the set of end users in various embodiments. The natural language representation of the task may be presented via one or more programmatic interfaces to an end user of the OAS in various embodiments. In at least one embodiment, in addition to presenting the natural language description or representation, one or more reasons for selecting or identifying the candidate optimization task may also be presented in natural language. In one such embodiment, a technique called “chain of thought” reasoning may be used by the GAIM or the TPA to provide the explanation of the selection of the candidate task. Presenting the explanation or reasoning may result in helping the end user understand the potential benefits of the proposed task, and may in general increase the confidence of the end user in the methodology being used to optimize the OTS.

In some embodiments, the end user may approve execution of the proposed candidate task via programmatic interfaces. In various embodiments, in response to determining that the candidate task has been approved, a TIA of the OAS may determine the executable steps that are needed to perform the approved task, and initiate execution of the task. As such, the TIA may have to in effect translate a natural language representation of an approved task into lower-level steps or actions that can be run using computing resources, tools and/or APIs accessible to the TIA, and then execute the steps or actions. In at least some embodiments, after the approved task has been implemented for an OTS, an indication of a change in values of one or more metrics of the OTS (relative to the values before the task was implemented) may be presented to the end user that approved the task. In at least some embodiments, a sequence or pipeline of GAIMs may be used for implementing an approved task as described below in further detail.

The fleets of TPAs and/or TIAs may be expanded (e.g., to enable automation of additional categories of optimization tasks) or contracted (e.g., after an OTS owner/administrator decides that a particular category of optimization task is not to be performed any longer) over time in various embodiments, e.g., in response to programmatic input from the owners/administrators of the OTSs. In at least one embodiment, new categories of optimization tasks may be identified autonomously by TPAs based on analysis of the OTS-related data sources. In one embodiment, if a new category of tasks identified autonomously by a TPA is approved by the owner/administrator of an OTS, a corresponding TIA for implementing such new tasks may be added to the TIA fleet. In some embodiments, various parameters for controlling the generation and/or execution of TPAs and TIAs may be specified by owners/administrators of the OTS, such as the triggering conditions for initiating execution of TPA GAIMs, triggering conditions for presenting candidate tasks to end users, the types of computing resources to be used for the TPAs and/or TIAs, etc.

In at least some embodiments, the end users to whom the proposed candidate tasks are presented for approval may not necessarily be aware of the fact that GAIMs are being used behind the scenes. From the end user perspective, the system components being used for proposing and implementing tasks may in effect be a black box in such embodiments

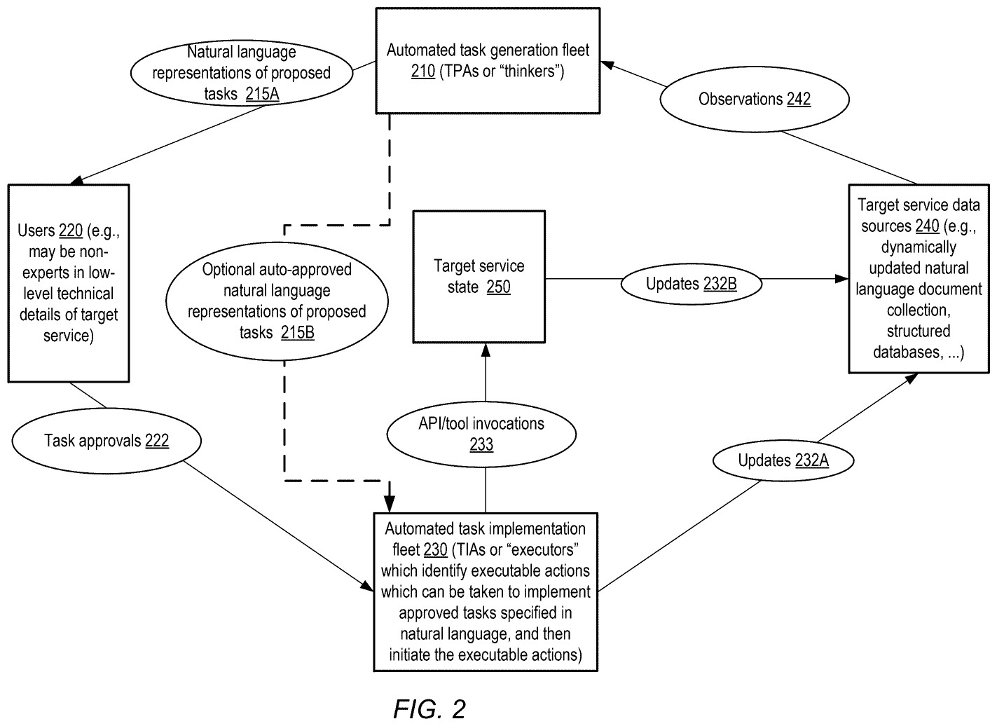

FIG. 2 illustrates a high level overview of an example continuous workflow for proposing and executing optimization tasks using multiple extensible fleets of GAI agents, according to at least some embodiments. Target service data sources 240 may include, among others, dynamically updated natural language document collections, dynamically updated structured database tables and the like in the depicted embodiment. In at least some embodiments, the content of at least some of the target service data sources may be updated frequently, e.g., once every few minutes on average. In at least one embodiment, the target service data sources may comprise documents and records stored at a diverse collection of data stores in different formats. In some embodiments, an indication of the set of data sources which contain information relevant to a given target service may be provided to an OAS similar in features and functionality to OAS 102 of FIG. 1 via programmatic interfaces by an owner or administrator of the target service.

An automated task generation fleet 210 comprising one or more TPAs established or configured for the target service may conduct analyses or observations 242 of the data sources 240 in the depicted embodiment. The TPAs may also be referred to as “thinkers” or “thinker agents” in some embodiments. Based on the observations or analyses, the task generation fleet may identify proposed optimization tasks for the target service, and present natural language representations of proposed tasks 215A to one or more end users 220 of the OAS in various embodiments. The end users need not be experts in low-level technical details of the target service in the depicted embodiment. The natural language representations may be worded by the TPAs using vocabularies that do not require deep technical understanding of the working or operations of the target service. In at least some embodiments, an explanation or set of reasons (expressed in natural language) for selecting or identifying the candidate proposed tasks may be provided via programmatic interfaces along with the descriptions or representations of the tasks themselves.

A user 220 may approve a proposed task in at least some cases, and a corresponding task approval 222 may be sent to an automated task implementation fleet 230. The task implementation fleet may comprise a set of TIAs or executors which identify executable actions that need to be taken to implement the approved tasks (which were specified in natural language), and then execute the actions. TIAs may also be referred to as “executors”. In at least some cases, the actions executed may comprise API or tool invocations 233 which modify target service state 250. The TIAs may submit updates 232A to the target service data sources 240 indicating for example the set of optimization tasks which have been initiated, the times at which the tasks were initiated, the APIs that were invoked, and so on. In at least some embodiments, changes to target service state (including changes resulting from the optimization tasks performed by the TIAs) may also be reflected in the target service data sources 240 via updates 232B initiated from tools monitoring the target service. The updates to the target service data sources may in turn result in the generation of additional optimization tasks, causing a new round of operations shown in FIG. 2.

In at least one embodiment, some categories of optimization tasks may be auto-approved and performed without requiring explicit approvals from end users. For example, after one or more rounds of interactions with the TPAs, an end user may gain enough confidence in the abilities of the TPAs and TIAs to use a programmatic interface of the OAS to indicate that subsequent proposal for tasks of one or more specified categories should be performed without waiting for approvals from the end user. Such optional auto-approved natural language representations of proposed tasks 215B may bypass the approval process and be sent directly to the implementation fleet 230 from the TPAs in the depicted embodiment, e.g., without presenting the natural language representations of the proposed tasks to an end user. The auto-approved tasks may then be implemented by the executors in a manner similar to the way in which explicitly approved tasks are implemented.

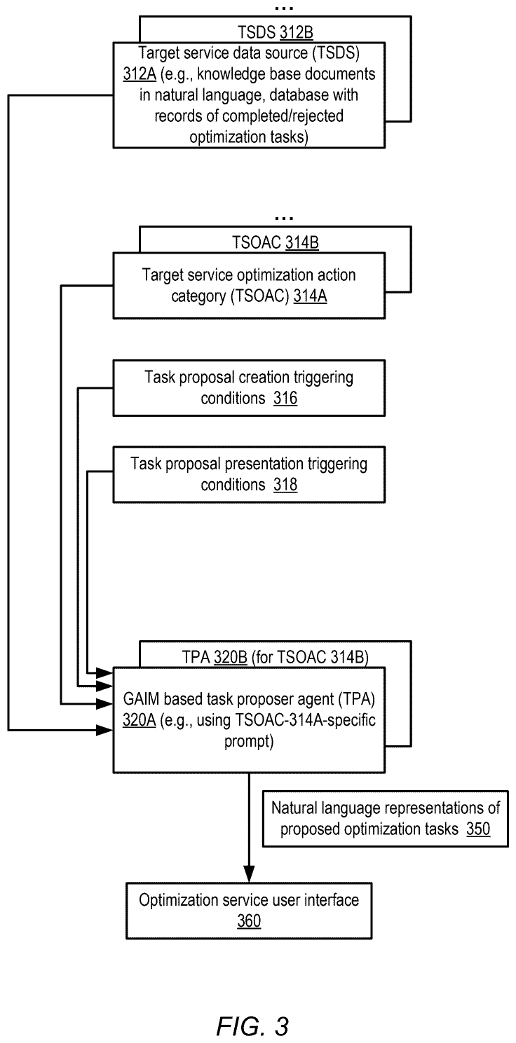

FIG. 3 illustrates example aspects of the generation of proposed optimization tasks, according to at least some embodiments. In the depicted embodiment, a set of target service optimization action categories (TSAOCs) such as TSAOC 314A and TSAOC 314B may be determined or identified for a particular target service. Corresponding to individual ones of the TSAOCs, respective GAIM based TPAs may be established or configured. For example, TPA 320A may be set up for TSAOC 314A, TPA 320B may be set up for TSAOC 314B, and so on. Similarly, for individual ones of the TSOACs, one or more target service data sources (TSDSs) such as TSDS 312A or TSDS 312B may be identified at an OAS.

The process of configuring a TPA may comprise identifying TSAOC-specific input prompts for one or more GAIMs of the TPA in some embodiments. In at least one embodiment, at least two levels of customization may be performed for prompts that are provided to GAIMs of the TPAs. First, a prompt template that comprises instructions for generating natural language descriptions of a specific optimization task may be obtained (e.g., from an owner/administrator of the target service, or from a prompt engineering team indicated by the owner/administrator). The prompt template may contain placeholders (e.g. placeholder text into which names or identifiers of specific data sources can be substituted) that can be customized for specific end users (or groups of end users) of the OAS (such as staff responsible for different aspects of operations of the target service). For example, consider a scenario in which optimization tasks of a particular category (such as definition of new end user segments to whom secondary content is to be propagated) need to be automated on behalf of two groups of OAS end users, G1 and G2. Data that can be useful to LLMs in the process of generating candidate tasks for G1 may be available from one data source DS1, while data that can be useful to LLMs in the process of generating candidate tasks for G2 may be available from a different data source DS2. The prompts used to generate tasks for end users of G1 may be customized to include a request to access DS1, while prompts used to generate tasks for end users of G2 may be customized to include a request to access DS2 by a TPA in some embodiments.

When a task proposal creation triggering condition 316 is satisfied, the TPA for the corresponding TSAOC may access the appropriate TSDS and generate a natural language representation of one or more proposed optimization tasks 350 in the depicted embodiment. When a task proposal presentation triggering condition 318 is satisfied, the representation of tone or more proposed tasks may be presented via an optimization service user interface 360 to an end user in various embodiments. In some embodiments, for example, new proposed tasks may be identified for a given group of end users once every hour, and the representations of the proposed tasks may be saved in a data structure of the OAS. The saved proposals (or a subset of the saved proposals) may be presented to a given end user if and when the end user logs in via an OAS interface in some embodiments, e.g., at the beginning of the workday for the end user. Records indicating which proposed tasks have been presented, which were then approved, and which were rejected may be retained in one of the TSDSs in some embodiments, and used by the TPAs to decide which proposed tasks should be presented to a particular end user. The task proposal creation triggering conditions 316 and/or the task proposal presentation triggering conditions 318 may be specified by an owner/administrator of the target service in some embodiments. Default triggering conditions (e.g., the equivalent of “generate new proposed tasks once every T1 minutes, and present proposed tasks to an end user every T2 minutes or the first time the end user logs in on a given business day”) may be used by the OAS.

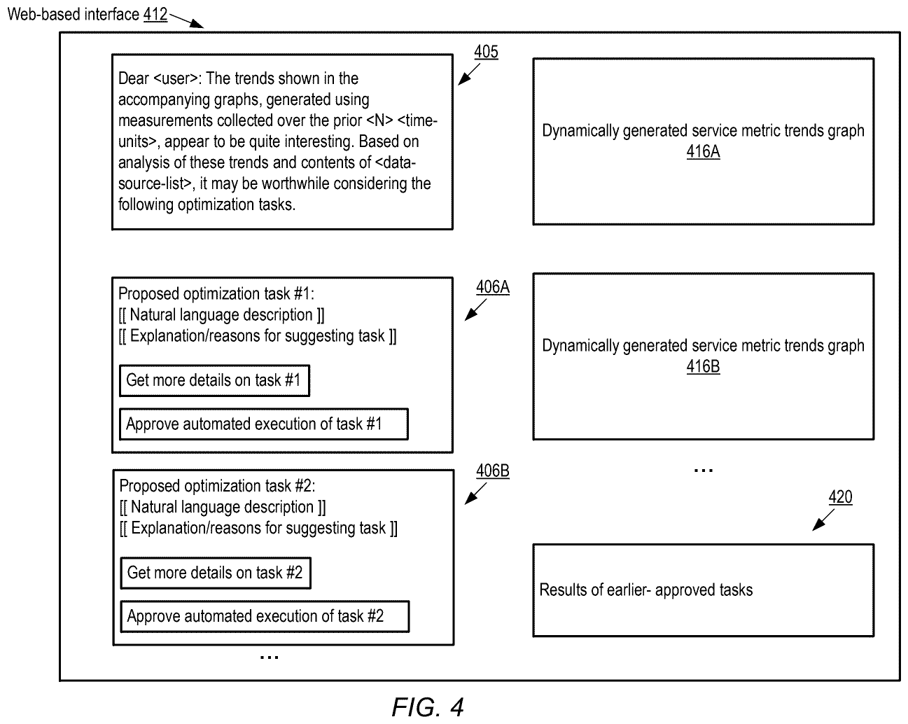

FIG. 4 illustrates an example web-based interface which may be used to present proposed optimization tasks for programmatic approval, according to at least some embodiments. In introductory section 405 of example web-based interface 412, an end user of an OAS similar in features and functionality to OAS 102 of FIG. 1 may be informed that measurements collected over a time period from a target service, when analyzed together with contents of a list of data sources pertaining to the service, suggest that one or more optimization tasks may be worth initiating in the depicted embodiment. The contents of web-based interface 412 may, for example be presented to the end user when the end user logs in to the OAS at the start of a business day, or based on other triggering conditions such as the determination that a particular amount of time has elapsed since a previous set of candidate optimization tasks were proposed to that end user.

Some of the data whose analysis that led the OAS to propose the candidate tasks may be displayed via dynamically generated service metric trends graph 416A or 416B in the depicted embodiment. Section 406A may comprise a natural language description or representation of a first proposed optimization task, along with explanations/reasons for suggesting the first task. Interactive interface elements may also be presented enabling the end user to get more details on the first proposed optimization task, and/or to approve the automated execution of the task. If the end user clicks on the button interface labeled “Get more details on task #1”, for example, natural language descriptions of a sequence of steps that collectively accomplish the task may be presented in some embodiments. Similarly, section 406B may comprise a natural language description or representation of a second proposed optimization task, along with explanations/reasons for suggesting the first task, interactive interface elements enabling the end user to get more details on the second proposed optimization task, and/or to approve the automated execution of the second proposed optimization task.

In the embodiment depicted in FIG. 4, web-based interface 412 may also include section 420 comprising an indication of results of one or more tasks which were approved earlier (e.g., prior to the presentation of the currently displayed propose tasks of sections 406A and 406B) by the end user. For example, section 420 may show changes in one or more service metrics subsequent to implementation of a particular optimization task which was implemented after approval from the end user. In one example, if the target service implements a portion of an online store, the displayed service metrics may indicate a change in the rate at which products of a particular category with which the earlier approved optimization task was associated performed were viewed, placed in a checkout cart and/or purchased subsequent to implementation of the optimization task.

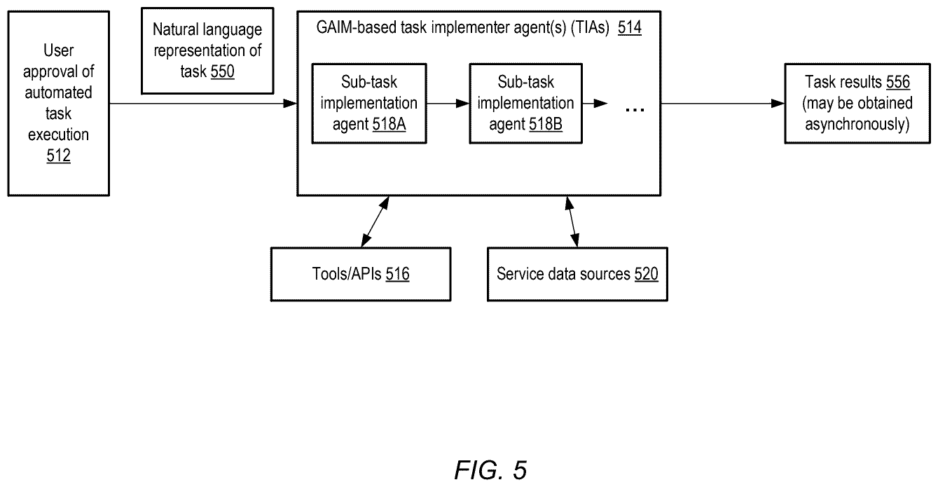

FIG. 5 illustrates aspects of a workflow for automated execution of an optimization task using a pipeline of GAI agents, according to at least some embodiments. After user approval of automated task execution 512 is obtained with respect to a particular optimization task proposed by a TPA of an OAS, a natural language representation of the task 550 may be provided to a collection of GAIM based task implementation agents (TIAs) 514 of the OAS in the depicted embodiment. In at least some embodiments, the process of converting the natural language description of an approved task into executable operations may be broken down into several sub-tasks of a pipeline, each sub-task being handled by a respective GAIM-based sub-task implementation agent such as 518A or 518B. Individual ones of the sub-task implementation agents may invoke any of a variety of tools/APIs 516, and/or examine contents of one or more service data sources 520 in the depicted embodiment.

In one embodiment, one of the sub-tasks performed may comprise submitting a question to a question answering GAIM of a sub-task implementation agent, asking the GAIM to indicate a logical sequence of steps needed to complete the optimization task should be performed. The question answering GAIM may obtain context information from service documentation available at a service data source 520 and provide an answer which indicates one or more database operations (e.g., queries or updates) that need to be performed to implement the task. Another sub-task, performed by a second GAIM-based sub-task implementation agent, may comprise determining which of a set of tables of a service-related database should be queried and/or updated to perform the database operations. A third sub-task may comprise generating commands (e.g., in a language similar to Structured Query Language or SQL) directed to the set of tables and verifying that the generated commands do not cause errors. Each of the GAIM-based sub-task implementation agents may thus perform a respective portion of the process for implementing the task in the embodiment depicted in FIG. 5, thereby restricting the scope of responsibilities of each of the GAIMs. If a single GAIM or TIA for accomplishing all the sub-tasks were to be used instead, in at least some embodiments this may result in poorer performance (e.g., an in increased probability of hallucinations or errors) than if a pipeline of smaller-scope GAIMs is used.

After all the steps are completed by the sub-task implementation agents, task results 556 may be obtained in the depicted embodiment. Task results may, for example, addition of one or more entries to a target service database, providing or displaying selected content (which may have been synthesized by sub-task implementation agents) to a set of target service end users of a particular user segment, changing a rate at which content is displayed to some end users of a particular user segment, and so on.

Note that while sub-task implementation agents 518A and 518B are shown in a sequence in FIG. 5, in general the sub-task implementation agents need not perform their tasks sequentially. In some embodiments, and for certain types of optimization tasks, a directed acyclic graph (DAG) of sub-task implementation agents may be employed. In such scenarios, some sub-tasks may be performed in parallel with other sub-tasks.

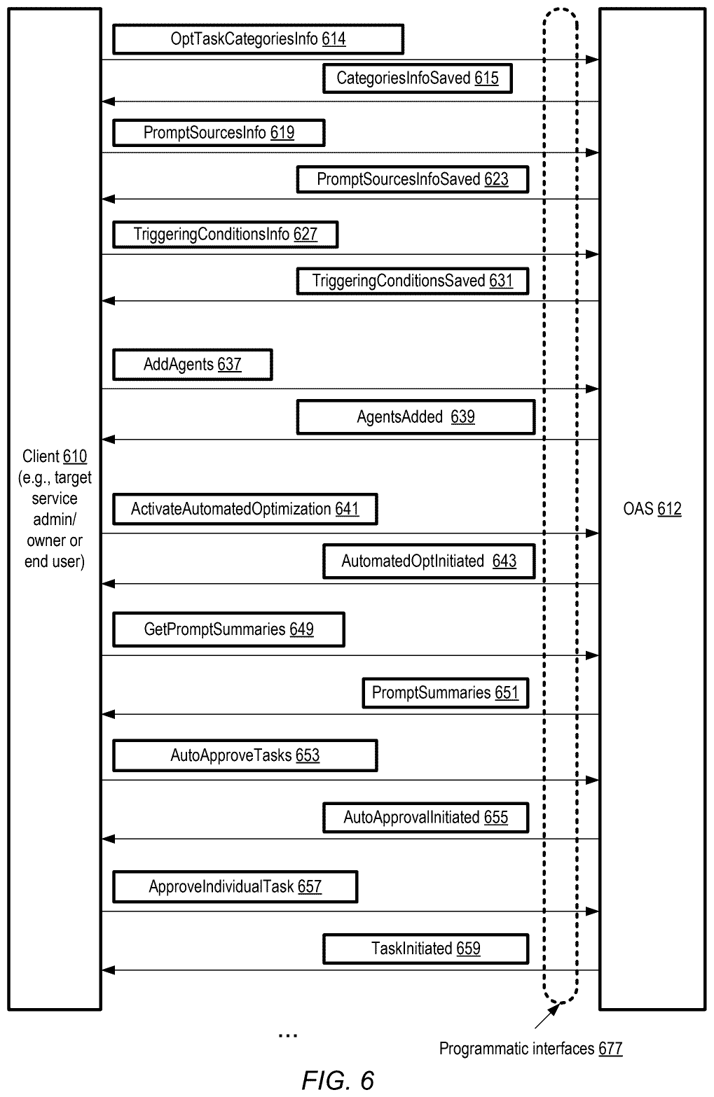

FIG. 6 illustrates example programmatic interactions between clients and an optimization automation service, according to at least some embodiments. An OAS 612, similar in features and functionality to OAS 102 of FIG. 1, may implement a set of programmatic interfaces 677 in the depicted embodiment, such as one or more web-based consoles, command-line tools, graphical user interfaces and/or APIs. At least two categories of clients 610 may utilize the programmatic interfaces 677 to communicate with the PAS in different embodiments. Some clients (e.g., administrators or owners of target service for which optimization tasks are to be automated) may utilize the programmatic interfaces 677 to submit requests and information pertaining to configuration or setup of the GAIM based agents used for automating optimization tasks. Other clients, such as end users of the OAS to whom generated candidate optimization tasks are presented, may use the programmatic interfaces 677 to approve/reject individual tasks or to automate approval of certain categories of optimization tasks.

A client 610 may submit an OptTaskCategoriesInfo message 614 to the OAS 612 via programmatic interfaces 677 to inform the OAS of various categories of optimization task pertinent to a particular target service, as well as the data sources from which information that can be used to generate proposed optimization tasks for the service and then perform the tasks may be extracted in the depicted embodiment. The provided information may be stored in a repository of the OAS, and a CategoriesInfoSaved message 615 may be sent to the client in some embodiments.

A PromptSourcesInfo message 619 may be submitted by a client to indicate the sources from which GAIM prompts (or prompt templates which can be customized for various end users or task categories) can be obtained by the OAS in various embodiments. In at least one embodiment, a set of prompts which can be used for one or more optimization task categories may be made available from a storage service or database indicated by the client. In another embodiment, the client may specify a set of prompt engineers (e.g., employees of an organization to which the client belongs) to which programmatic requests for prompts for various GAIM agents can be sent from the OAS. The prompt-related information may be saved at the OAS, and a PromptSourcesInfoSaved message 623 may be sent to the client in one embodiment.

In at least some embodiments, a client may specify the circumstances or criteria which are to trigger the generation or identification of new candidate optimization tasks to be presented to one or more end users of the OAS, as well as the circumstances or criteria which are to trigger the actual presentation of the natural language representations of the new candidate optimization tasks. Such information may be provided via one or more TriggeringConditionsInfo messages 627. The information about the triggering conditions may be saved at the OAS, and a TriggeringConditionsSaved message 631 may be sent to the client in the depicted embodiment. In one embodiment, the generation or identification of new candidate optimization tasks may be triggered, for example, based on detecting that one or more of the target service data sources have been updated since the previous execution of a TPA, and/or based on detecting that a certain amount of time has elapsed since the previous execution of a TPA.

As indicated earlier, the fleets of TPAs and/or TIAs used for a given target service may be extensible in some embodiments. An AddAgents request 637 may be submitted by a client in some embodiments to indicate that one or more addition TPAs and/or TIAs should be added to the fleets of agents being used for a specified target service. In at least some embodiments, a client may use programmatic interfaces 677 to specify hosting preferences for the TPAs and/or TIAs—e.g., the types of computing resources (such as compute instances or virtual machines with access to machine learning accelerators including Graphics Processing Units (GPUs) or other machine learning optimized hardware with specified performance characteristics) that are to be added, as well as the existing TPAs or TIAs. The OAS may cause the agents to be hosted, e.g., at the specified types of cloud based computing resources, and send an AgentsAdded message 639 to the client.

An ActivateAutomatedOptimization request 641 may be sent to the OAS in some embodiments to start a workflow of automated optimization for a target service, e.g., similar to the workflow shown in FIG. 2. The OAS may start the workflow, e.g., by monitoring for triggering conditions to cause new tasks to be identified and presented to OAS users, and send an AutomationOptInitiated message 643 to the client in the depicted embodiment.

In at least some embodiments, a client may request information about the prompts being used for one or more TPAs and/or TIAs, e.g., by sending a GetPromptSummaries request 649 to the OAS. Summaries of the prompts being used may be sent to the client via one or more PromptSummaries messages 651 in one embodiment. The prompt summaries may themselves be generated by LLMs of the OAS in some embodiments. In other embodiments, the creators of the prompts (e.g., prompt engineers) may provide the summaries to the OAS.

An AutoApproveTasksOfCategory 653 may be sent to the OAS, e.g., by an administrator or owner of a target service, or by and end user, to indicate that explicit approvals of proposed optimization tasks of one or more categories are no longer required, e.g., that such tasks should be implemented without presenting their natural language descriptors to end users. Such auto-approval may be initiated after a set of end users and/or the owner of the target service has gained confidence in the abilities of the TPAs to generate useful candidate tasks, for example. An AutoApprovalInitiated messages 655 may be sent to the client in some embodiments, indicating that subsequent candidate tasks of the specified types may be implemented as soon as they are identified, without requiring explicit approvals from end users. In at least some embodiments, a DisableAutoApproval message may be sent to the OAS to stop automated approval of subsequent proposed tasks of one or more categories.

A client may approve individual proposed optimization tasks via ApproveIndividualTask messages 657 in some embodiments. Such messages would have similar results to those achieved by an end user by clicking on an “Approve automated execution of task” interface element of the kind shown in sections 406A or 406B of web-based interface 412 of FIG. 4. The approved task may be started using one or more TIAs in the depicted embodiment, and a TaskInitiated message 659 may be sent to the client in at least some embodiments.

It is noted that in some embodiments, programmatic interactions other than those shown in FIG. 6 may be supported by an OAS for operations related to automating optimization tasks.

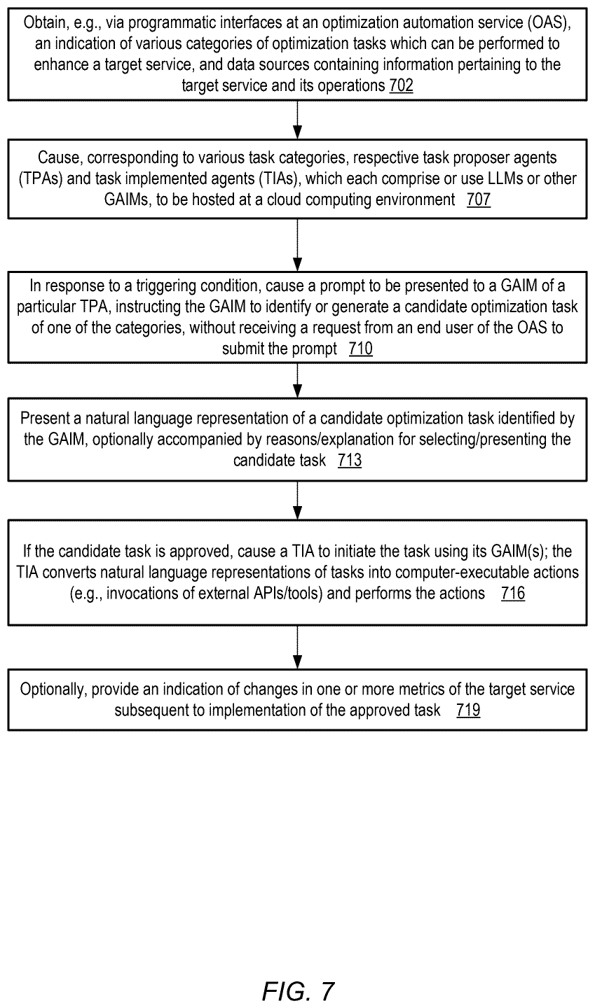

FIG. 7 is a flow diagram illustrating aspects of operations pertaining to automation of optimization tasks using GAI agent fleets, according to at least some embodiments. As shown in element 702, an indication of one or more categories of optimization tasks which can be performed to enhance operations of a target service may be obtained, e.g., from a target service owner or administrator, via programmatic interfaces of an optimization automation service (OAS) similar in features and functionality to OAS 102 of FIG. 1. In addition, in at least some embodiments, an indication of one or more data sources containing information pertaining to the working of the target service may also be obtained via programmatic interfaces at an OAS.

Corresponding to individual ones of the categories, respective task proposer agents (TPAs) and task implementation agents (TIAs) may be caused to be hosted using resources of a cloud provider network or cloud computing environment in various embodiments (element 707). Individual ones of the TPAs and/or TIAs may for example comprise software that invokes one or more LLMs or other GAIMs, e.g., using prompts that have been dynamically updated by the software (e.g., by inserting identifiers or locations of specific data sources, relevant to one or more OAS end users and a corresponding target service, that may have changed recently). The TPAs and/or the TIAs may in some embodiments comprise respective sets of one or more GAIMs.

In response to a triggering condition, a prompt may be presented to a GAIM of a particular TPA in the depicted embodiment, instructing that GAIM to identify or generate one or more candidate optimization tasks of a particular category, without receiving a request from an end user to submit the prompt (element 710). The prompt may cause the GAIM to analyze content of one or more of the data sources associated with the service and generate a natural language description or representation of at least one new candidate task that it has identified as a suitable task to enhance operations of the service (such as a task that is directed to increasing or enhancing user engagement of end users with the target service).

A natural language representation of the candidate optimization task identified by the TPA GAIM may be presented, e.g., via programmatic interfaces of the OAS to an end user of the OAS in various embodiments (element 713). In at least one embodiment, in addition to a description of the candidate task, a set of reasons or an explanation of why the candidate optimization task was generated, selected, proposed or presented may be provided, also in natural language. The explanation may for example indicate that similar tasks were performed earlier for the target service, the measured benefits of such tasks, etc. In at least one embodiment, a GAIM which uses chain-of-thought reasoning may be used, and various steps in the reasoning may be represented in the explanation.

In at least some embodiments, if a presented candidate optimization task is approved, one or more TIAs may be caused to initiate the approved task using its own GAIM(s) (element 716). The TIA may be provided a natural language description or representation of the task (e.g., the representation which was presented by the TPA to an end user who approved the task), convert or translate that natural language representation into one or more lower-level computer-executable operations, and then execute the operations in various embodiments. In at least some embodiments, one or more APIs or tools external to the OAS may be invoked to implement the task. In some embodiments, the overall task may be divided into a sequence, pipeline or graph of lower-level sub-tasks, and respective sub-tasks may be executed by a respective sub-task implementation agent or sub-task GAIM.

In at least one embodiment, after an approved optimization task is performed, an indication of changes in one or more metrics of the target service subsequent to the implementation of the task may optionally be provided via programmatic interfaces of the OAS, e.g., to a user who approved the task, to a peer group of users, and/or to a supervisor of the approver (element 719). It is noted that in various embodiments, some of the operations shown in the flow diagram of FIG. 7 may be implemented in a different order than that shown, or may be performed in parallel rather than sequentially. Additionally, some of the operations shown in the flow diagram may not be required in one or more implementations.

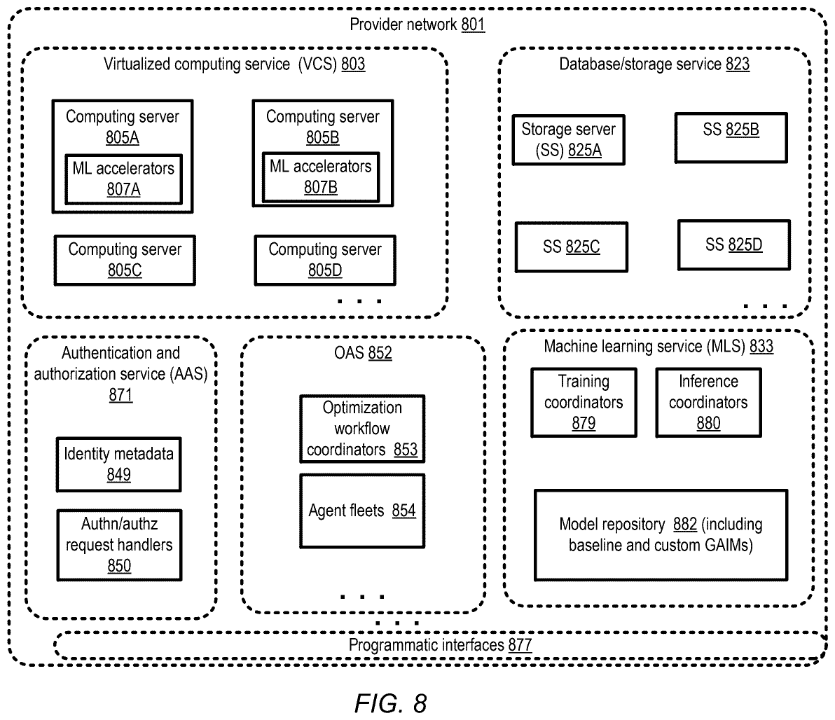

As indicated earlier, in some embodiments an OAS service may be implemented at a cloud provider network or cloud computing environment. FIG. 8 illustrates an example provider network at which an optimization automation service may be implemented, according to at least some embodiments. In the depicted embodiment, provider network 801 may comprise resources used to implement a plurality of network-accessible services, including for example a virtualized computing service (VCS) 803, a database/storage service 823, an authentication and authorization service (AAS) 871, a machine learning service (MLS) 833 in addition to an OAS 852. The OAS may comprise optimization workflow coordinators 853 that orchestrate workflows of the kind shown in FIG. 2, as well as agent fleets 854 comprising TPAs and/or TIAs of the kind introduced earlier. The MLS 833 may comprise training coordinators 879 and inference coordinators 880 in the depicted embodiment. Training coordinators 879 may be responsible for training various types of machine learning models including initial baseline versions of GAIMs, as well as for conducting fine tuning of the GAIMs if desired by the GAIM owners. Inference coordinators 880 may manage the execution of inference workflows for various models. In at least some embodiments, model repository 882 may be used to store code and artifacts of at least GAIMs which may be invoked by or used as part of TPAs and/or TIAs of agent fleets 854.

In the embodiment shown in FIG. 8, the VCS may comprise a plurality of servers (e.g., servers 805A, 805B, 805C or 805D). Respective groups of compute instances or virtual machines may be run on individual ones of the computing servers at the request of provider network clients. At least some of the servers may include a set of machine learning accelerators (MLAs) such as 807A or 807B, which may be used for training or executing GAIMs, including GAIMs used by TPAs and/or TIAs. At least some target services may be implemented in part using the VCS. Large data sets used for training GAIMs, and/or learned weights of the GAIMs, may be stored using storage servers (SSs) of database/storage service 823, such as SS 825A, 825B, 825C or 825D. In some embodiments, at least a portion of the target service data stores may be located at the SSs. The AAS 871 may be used to manage permissions pertaining to the use of models of MLS 833; for example, identity metadata 849 may be utilized by authentication/authorization request handlers 850 at the request of optimization workflow coordinators 853 to determine whether a given end user is permitted to access the OAS and/or whether TPAs or TIAs can be invoked on behalf of the end user. The AAS may also be utilized to ensure that data pertaining to a given target service on behalf of a provider network customer is only utilized to optimize operations of that service and that customer. Components of a given service of a provider network may thus in general utilize components of other services in the depicted embodiment. Individual ones of the services shown in FIG. 8 may implement a respective set of programmatic interfaces 877 which can be used by external and/or internal clients (where the internal clients may comprise components of other services) in one embodiment. In at least some embodiments, resources of a cloud provider network may not be required for the kinds of techniques introduced above; instead, for example, a standalone set of resources may be used.

A cloud provider network can be formed as a number of regions, where a region is a separate geographical area in which the cloud provider clusters data centers. Such a region may also be referred to as a provider network-defined region, as its boundaries may not necessarily coincide with those of countries, states, etc. Each region can include two or more availability zones connected to one another via a private high-speed network, for example a fiber communication connection. An availability zone (also known as an availability domain, or simply a “zone”) refers to an isolated failure domain including one or more data center facilities with separate power, separate networking, and separate cooling from those in another availability zone. A data center refers to a physical building or enclosure that houses and provides power and cooling to servers of the cloud provider network. Preferably, availability zones within a region are positioned far enough away from one other that the same natural disaster should not take more than one availability zone offline at the same time. Customers can connect to availability zones of the cloud provider network via a publicly accessible network (e.g., the Internet, a cellular communication network) by way of a transit center (TC). TCs can be considered as the primary backbone locations linking customers to the cloud provider network and may be collocated at other network provider facilities (e.g., Internet service providers, telecommunications providers) and securely connected (e.g. via a VPN or direct connection) to the availability zones. Each region can operate two or more TCs for redundancy. Regions are connected to a global network connecting each region to at least one other region. The cloud provider network may deliver content from points of presence outside of, but networked with, these regions by way of edge locations and regional edge cache servers (points of presence, or PoPs). This compartmentalization and geographic distribution of computing hardware enables the cloud provider network to provide low-latency resource access to customers on a global scale with a high degree of fault tolerance and stability.

In some embodiments, an OAS may be implemented at least in part using an edge location of the provider network instead of or in addition to regional data centers. An edge location (or “edge zone”), as referred to herein, can be structured in several ways. In some implementations, an edge location can be an extension of the cloud provider network substrate including a limited quantity of capacity provided outside of an availability zone (e.g., in a small data center or other facility of the cloud provider that is located close to a customer workload and that may be distant from any availability zones). Such edge locations may be referred to as provider network extension sites or local zones (due to being more local or proximate to a group of users than traditional availability zones). A local zone may be connected in various ways to a publicly accessible network such as the Internet, for example directly, via another network, or via a private connection to a region. In some implementations, an edge location may be an extension of the cloud provider network substrate formed by one or more servers located on-premise in a customer or partner facility, wherein such server(s) communicate over a network (e.g., a publicly-accessible network such as the Internet) with a nearby availability zone or region of the cloud provider network. This type of substrate extension located outside of cloud provider network data centers can be referred to as an “outpost”of the cloud provider network.

A VCS of the cloud provider network may offer virtual compute instances (also referred to as virtual machines, or simply “instances”) with varying computational and/or memory resources in various embodiments, which may be used to implement components of an OAS (or other related services) or to perform distributed training of machine learning models. In one embodiment, each of the virtual compute instances may correspond to one of several instance types, families or categories, and instances of any of several families may be employed for computations of the MLS or OAS. An instance type may be characterized by its hardware type, computational resources (e.g., number, type, and configuration of central processing units (CPUs) or CPU cores, GPUs, ML accelerators or hardware accelerators for other types of tasks), memory resources (e.g., capacity, type, and configuration of local memory), storage resources (e.g., capacity, type, and configuration of locally accessible storage), network resources (e.g., characteristics of its network interface and/or network capabilities), and/or other suitable descriptive characteristics (such as being a “burstable” instance type that has a baseline performance guarantee and the ability to periodically burst above that baseline, a non-burstable or dedicated instance type that is allotted and guaranteed a fixed quantity of resources, or an instance type optimized for radio-based applications). Each instance type can have a specific ratio of processing, local storage, memory, and networking resources, and different instance families may have differing types of these resources as well. Multiple sizes of these resource configurations can be available within a given instance type. Using instance type selection functionality, an instance type may be selected for a customer, e.g., based (at least in part) on input from the customer. For example, a customer may choose an instance type from a predefined set of instance types. As another example, a customer may specify the desired resources of an instance type and/or requirements of a workload that the instance will run, and the instance type selection functionality may select an instance type based on such a specification. A suitable host for the requested instance type can be selected based at least partly on factors such as collected network performance metrics, resource utilization levels at different available hosts, and so on.

The traffic and operations of the cloud provider network, and individual services such as the MLS, may broadly be subdivided into two categories in various embodiments: control plane operations and data plane operations. While the data plane represents the movement of data through the distributed computing system, the control plane represents the movement of control signals through the distributed computing system. The control plane generally includes one or more control plane components distributed across and implemented by one or more control servers. Control plane traffic generally includes administrative operations, such as system configuration and management (e.g., resource placement, hardware capacity management, diagnostic monitoring, or system state information management). The data plane includes customer resources that are implemented on the cloud provider network (e.g., computing instances, containers, block storage volumes, databases, or file storage). Data plane traffic generally includes non-administrative operations such as transferring customer data to and from the customer resources. Certain control plane components (e.g., tier one control plane components such as the control plane for a virtualized computing service) are typically implemented on a separate set of servers from the data plane servers, while other control plane components (e.g., tier two control plane components such as analytics services) may share the virtualized servers with the data plane, and control plane traffic and data plane traffic may be sent over separate/distinct networks.

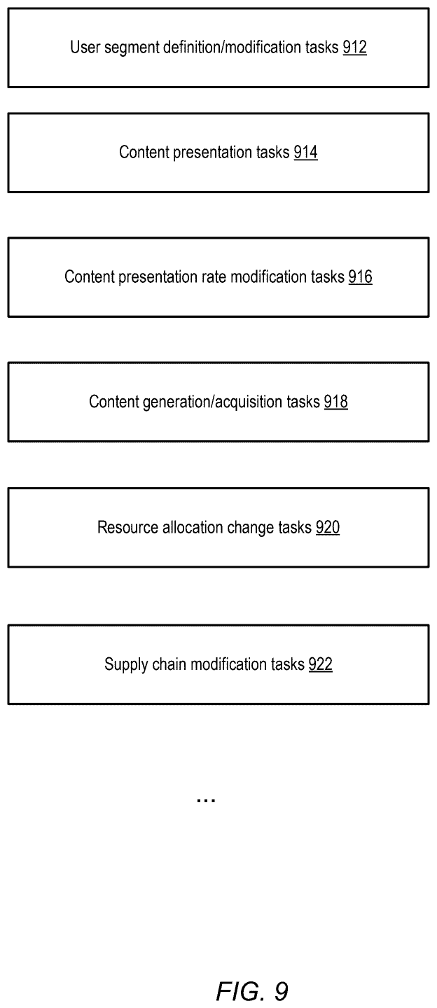

FIG. 9 illustrates example categories of optimization tasks which may be performed for one or more target services by an optimization automation service, according to at least some embodiments. User segment definition/modification tasks 912 may comprise creating or modifying groups of target service end users based on one or more common characteristics or user properties identified from the data stores associated with the target service in some embodiments. For example, some user segments may be defined based on geographical locations of users, age ranges, device types utilized by the end users, end user product or function preferences as indicated by records of user interactions with the target service, and so on. Creating new user segments may, for example, be part of a workflow for communicating with the members of the segments, e.g., by offering samples of content which may lead to higher levels of user engagement and so on.

Content presentation tasks 914 may involve deciding which particular types of content would lead to increased engagement by end users of a segment, and causing at least some content of those types to be presented to the end users in the depicted embodiment. Content presentation rate modification tasks 916 may comprise changing the timing or frequency with which content is presented to end users of a segment in some embodiments. Content generation/acquisition tasks 918 may comprise synthesizing (e.g., using GAIMs) content for presentation to some end user segments, or acquiring content from external sources for such presentation in various embodiments. Resource allocation change tasks 920 may comprise determining how a constrained set of resources or budget (e.g., a budget for digital marketing related bids) should be distributed (or re-distributed) with respect to various end user segments, and/or at what rate the resources should be consumed during a chosen time period. In some embodiments, depending on the target service, one or more of the applicable optimization tasks may comprise supply chain modification tasks 922—e.g., a decision to diversify suppliers of a given product offered by an online store by choosing suppliers in different countries may be made, or a decision to change the delivery/transport mechanism for one or more products may be made. The list of example tasks shown in FIG. 9 is not intended to be comprehensive; different combinations of optimization task categories may be identified in some embodiments than those shown in FIG. 9. The techniques introduced herein may be utilized to optimize services in a number of different domains, such as but not limited to online store management, supply chain management, financial services, insurance, digital marketing, content presentation and the like.

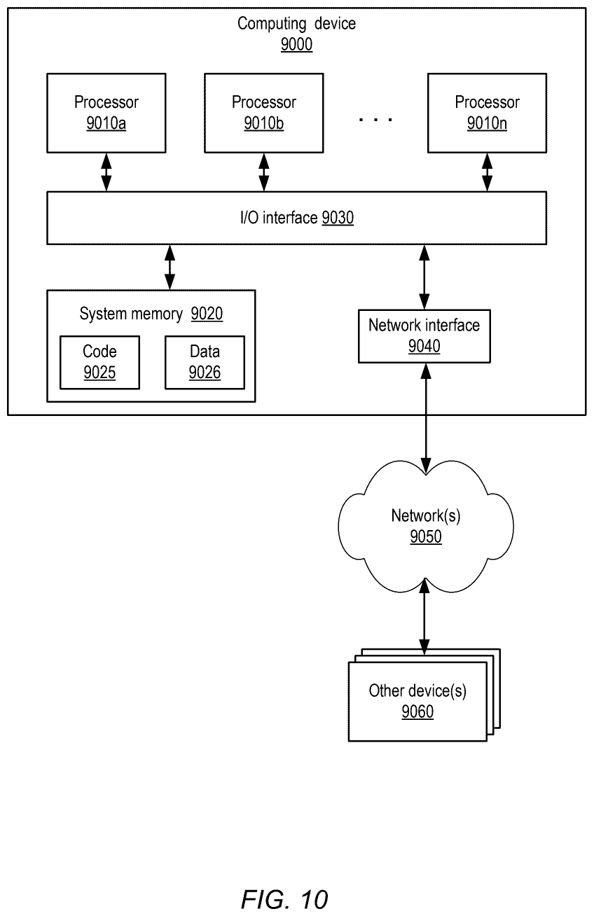

In at least some embodiments, a server that implements the types of techniques described herein (e.g., including the described functionality of various OAS components and components of other services of cloud provider networks), may include a general-purpose computer system that includes or is configured to access one or more computer-accessible media. FIG. 10 illustrates such a general-purpose computing device 9000. In the illustrated embodiment, computing device 9000 includes one or more processors 9010 coupled to a system memory 9020 (which may comprise both non-volatile and volatile memory modules) via an input/output (I/O) interface 9030. Computing device 9000 further includes a network interface 9040 coupled to I/O interface 9030.

In various embodiments, computing device 9000 may be a uniprocessor system including one processor 9010, or a multiprocessor system including several processors 9010 (e.g., two, four, eight, or another suitable number). Processors 9010 may be any suitable processors capable of executing instructions. For example, in various embodiments, processors 9010 may be general-purpose or embedded processors implementing any of a variety of instruction set architectures (ISAs), such as the x86, PowerPC, SPARC, ARM, or MIPS ISAs, or any other suitable ISA. In multiprocessor systems, each of processors 9010 may commonly, but not necessarily, implement the same ISA. In some implementations, graphics processing units (GPUs) and or field-programmable gate arrays (FPGAs) may be used instead of, or in addition to, conventional processors.

System memory 9020 may be configured to store instructions and data accessible by processor(s) 9010. In at least some embodiments, the system memory 9020 may comprise both volatile and non-volatile portions; in other embodiments, only volatile memory may be used. In various embodiments, the volatile portion of system memory 9020 may be implemented using any suitable memory technology, such as static random-access memory (SRAM), synchronous dynamic RAM or any other type of memory. For the non-volatile portion of system memory (which may comprise one or more NVDIMMs, for example), in some embodiments flash-based memory devices, including NAND-flash devices, may be used. In at least some embodiments, the non-volatile portion of the system memory may include a power source, such as a supercapacitor or other power storage device (e.g., a battery). In various embodiments, memristor based resistive random-access memory (ReRAM), three-dimensional NAND technologies, Ferroelectric RAM, magnetoresistive RAM (MRAM), or any of various types of phase change memory (PCM) may be used at least for the non-volatile portion of system memory. In the illustrated embodiment, program instructions and data implementing one or more desired functions, such as those methods, techniques, and data described above, are shown stored within system memory 9020 as code 9025 and data 9026.

In one embodiment, I/O interface 9030 may be configured to coordinate I/O traffic between processor 9010, system memory 9020, and any peripheral devices in the device, including network interface 9040 or other peripheral interfaces such as various types of persistent and/or volatile storage devices. In some embodiments, I/O interface 9030 may perform any necessary protocol, timing or other data transformations to convert data signals from one component (e.g., system memory 9020) into a format suitable for use by another component (e.g., processor 9010). In some embodiments, I/O interface 9030 may include support for devices attached through various types of peripheral buses (including hardware accelerators of various kinds), such as a variant of the Peripheral Component Interconnect (PCI) bus standard or the Universal Serial Bus (USB) standard, for example. In some embodiments, the function of I/O interface 9030 may be split into two or more separate components, such as a north bridge and a south bridge, for example. Also, in some embodiments some or all of the functionality of I/O interface 9030, such as an interface to system memory 9020, may be incorporated directly into processor 9010.

Network interface 9040 may be configured to allow data to be exchanged between computing device 9000 and other devices 9060 attached to a network or networks 9050, such as other computer systems or devices as illustrated in FIG. 1 through FIG. 9, for example. In various embodiments, network interface 9040 may support communication via any suitable wired or wireless general data networks, such as types of Ethernet network, for example. Additionally, network interface 9040 may support communication via telecommunications/telephony networks such as analog voice networks or digital fiber communications networks, via storage area networks such as Fibre Channel SANs, or via any other suitable type of network and/or protocol.

In some embodiments, system memory 9020 may represent one embodiment of a computer-accessible medium configured to store at least a subset of program instructions and data used for implementing the methods and apparatus discussed in the context of FIG. 1 through FIG. 9. However, in other embodiments, program instructions and/or data may be received, sent or stored upon different types of computer-accessible media. Generally speaking, a computer-accessible medium may include non-transitory storage media or memory media such as magnetic or optical media, e.g., disk or DVD/CD coupled to computing device 9000 via I/O interface 9030. A non-transitory computer-accessible storage medium may also include any volatile or non-volatile media such as RAM (e.g., SDRAM, DDR SDRAM, RDRAM, SRAM, etc.), ROM, etc., that may be included in some embodiments of computing device 9000 as system memory 9020 or another type of memory. In some embodiments, a plurality of non-transitory computer-readable storage media may collectively store program instructions that when executed on or across one or more processors implement at least a subset of the methods and techniques described above. A computer-accessible medium may further include transmission media or signals such as electrical, electromagnetic, or digital signals, conveyed via a communication medium such as a network and/or a wireless link, such as may be implemented via network interface 9040. Portions or all of multiple computing devices such as that illustrated in FIG. 10 may be used to implement the described functionality in various embodiments; for example, software components running on a variety of different devices and servers may collaborate to provide the functionality. In some embodiments, portions of the described functionality may be implemented using storage devices, network devices, or special-purpose computer systems, in addition to or instead of being implemented using general-purpose computer systems. The term “computing device”, as used herein, refers to at least all these types of devices, and is not limited to these types of devices.

### Conclusion

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g., SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the Figures and described herein represent exemplary embodiments of methods. The methods may be implemented in software, hardware, or a combination thereof. The order of method may be changed, and various elements may be added, reordered, combined, omitted, modified, etc.

Various modifications and changes may be made as would be obvious to a person skilled in the art having the benefit of this disclosure. It is intended to embrace all such modifications and changes and, accordingly, the above description to be regarded in an illustrative rather than a restrictive sense.

What is claimed is:

1. A system, comprising:
one or more computing devices;
wherein the one or more computing devices include instructions that upon execution on or across the one or more computing devices cause the one or more computing devices to:
identify, at an optimization automation service of a cloud computing environment, (a) a plurality of user engagement optimization task categories of a target service and (b) a plurality of dynamically updated data sources associated with the target service, including at least a first data source comprising documentation in natural language;
cause, corresponding to individual ones of the plurality of user engagement optimization task categories, (a) respective task proposer agents and (b) respective task implementer agents to be hosted at the cloud computing environment, wherein individual ones of the respective task proposer agents utilize a respective language model, and wherein individual ones of the respective task implementer agents utilize a respective language model;
automatically present, in response to detection of a first triggering condition, a first prompt to a first language model of a first task proposer agent of the respective task proposer agents, without receiving a request from an end user of the optimization automation service to invoke the first task proposer agent, wherein the first prompt instructs the first language model to, based at least in part on analysis of content of the first data source, identify a first candidate optimization task of a first user engagement optimization task category of the plurality of user engagement optimization task categories;
present, via one or more programmatic interfaces to a first end user of the optimization automation service, in response to detection of a second triggering condition, (a) a natural language representation of the first candidate optimization task and (b) one or more reasons for presentation of the first candidate optimization task to the first end user;
in response to obtaining approval, via the one or more programmatic interfaces, of the first candidate optimization task from the first end user,
cause a first task implementer agent of the respective task implementer agents to initiate, using at least a first language model of the first task implementer agent, the first candidate optimization task; and
present, via the one or more programmatic interfaces, an indication of a change, subsequent to implementation of the first candidate optimization task, in a metric of the target service.

2. The system as recited in claim 1, wherein the one or more computing devices include further instructions that upon execution on or across the one or more computing devices further cause the one or more computing devices to:
obtain, from an administrator of the target service, via one or more additional programmatic interfaces, an indication of one or more of (a) the first user engagement optimization task category or (b) the first data source.

3. The system as recited in claim 1, wherein the one or more computing devices include further instructions that upon execution on or across the one or more computing devices further cause the one or more computing devices to:
obtain, from an administrator of the target service, via one or more additional programmatic interfaces, an indication of one or more of: (a) the first triggering condition or (b) the second triggering condition.

4. The system as recited in claim 1, wherein the one or more computing devices include further instructions that upon execution on or across the one or more computing devices further cause the one or more computing devices to:
cause, based at least in part on input received via one or more additional programmatic interfaces, another task proposer agent to be hosted at the cloud computing environment, wherein the other task proposer agent is configured to identify candidate optimization tasks of another user engagement optimization task category.

5. The system as recited in claim 1, wherein the one or more computing devices include further instructions that upon execution on or across the one or more computing devices further cause the one or more computing devices to:
cause a second task implementer agent of the respective task implementer agents to initiate, using at least a second language model of the second task implementer agent, a second candidate optimization task identified by a second task proposer agent of the respective task proposer agents, wherein the second candidate optimization task is initiated without presenting a natural language representation of the second candidate optimization task to an end user.

6. A computer-implemented method, comprising:
configuring, corresponding to individual ones of a plurality of optimization task categories of a target service, respective task proposer agents, wherein individual ones of the respective task proposer agents comprise a respective generative artificial intelligence model (GAIM);
presenting a first prompt to a first GAIM of a first task proposer agent of the respective task proposer agents, wherein the first prompt instructs the first GAIM to, based at least in part on analysis of content of one or more natural language data sources, identify a first candidate optimization task of a first optimization task category of the plurality of optimization task categories; and
in response to obtaining approval, via one or more programmatic interfaces, of the first candidate optimization task, causing the first candidate optimization task to be initiated.

7. The computer-implemented method as recited in claim 6, further comprising:
configuring, corresponding to individual ones of the plurality of optimization task categories of a target service, respective task implementer agents, wherein individual ones of the respective task implementer agents comprise a respective GAIM, and wherein the first candidate optimization task is initiated by a particular GAIM of a first task implementer agent of the respective task implementer agents.

8. The computer-implemented method as recited in claim 6, further comprising:
presenting, via the one or more programmatic interfaces, a natural language explanation for identification of the first candidate optimization task.

9. The computer-implemented method as recited in claim 6, wherein the first prompt is presented to the first GAIM based at least in part on detecting that a first triggering condition has been satisfied, wherein said detecting comprises determining that a first data source of the one or more natural language data sources has been updated since a previous execution of the first task proposer agent.

10. The computer-implemented method as recited in claim 6, further comprising:
obtaining, via the one or more programmatic interfaces, an indication of a triggering condition for presenting the first prompt to the first GAIM, wherein the first prompt is presented to the first GAIM based at least in part on detecting that the triggering condition has been satisfied.

11. The computer-implemented method as recited in claim 6, further comprising:
presenting, via the one or more programmatic interfaces, prior to said obtaining approval, an indication of the first candidate optimization task in response to detecting that a triggering condition has been satisfied.

12. The computer-implemented method as recited in claim 11, wherein detecting that the triggering condition has been satisfied comprises one or more of: (a) detecting that a first end user has logged in to a system or (b) detecting that an amount of time that has elapsed since another candidate optimization action was presented to a first end user satisfies a criterion.

13. The computer-implemented method as recited in claim 6, further comprising:
receiving, via the one or more programmatic interfaces, an indication of the plurality of optimization task categories.

14. The computer-implemented method as recited in claim 6, further comprising:
receiving, via the one or more programmatic interfaces, an indication of one or more data sources to be utilized for identifying candidate optimization tasks, including at least a first natural language data source of the one or more natural language data sources.

15. The computer-implemented method as recited in claim 6, wherein the first candidate optimization task comprises one or more of: (a) causing an additional end user segment of the target service to be defined, (b) causing content to be presented to an end user segment of the target service, (c) changing a rate at which content is presented to an end user segment of the target service, or (d) changing an allocation of resources associated with presentation of content to end users of the target service.

16. One or more non-transitory computer-accessible storage media storing program instructions that when executed on or across one or more processors:
configure, corresponding to individual ones of a plurality of optimization task categories of a target service, respective generative artificial intelligence models (GAIMs);
present a first prompt to a first GAIM of the respective GAIMs, wherein the first prompt instructs the first GAIM to, based at least in part on analysis of content of one or more data sources, identify a first candidate optimization task of a first optimization task category of the plurality of optimization task categories; and
cause the first candidate optimization task, identified by the first GAIM, to be initiated using another GAIM.

17. The one or more non-transitory computer-accessible storage media as recited in claim 16, wherein contents of the one or more data sources comprise one or more of: a knowledge base entry of the target service, documentation of the target service, one or more records indicating a metric trend of the target service, one or more records indicating an optimization task of the target service which was approved earlier, or one or more records indicating an optimization task of the target service which was rejected earlier.

18. The one or more non-transitory computer-accessible storage media as recited in claim 16, storing further program instructions that when executed on or across the one or more processors:
present, via one or more programmatic interfaces, a natural language explanation for identification of the first candidate optimization task.

19. The one or more non-transitory computer-accessible storage media as recited in claim 16, storing further program instructions that when executed on or across the one or more processors:
present, via one or more programmatic interfaces, a summary of the first prompt.

20. The one or more non-transitory computer-accessible storage media as recited in claim 16, wherein individual ones of the respective GAIMs are configured to run at respective computing resources of a virtualized computing service of a cloud provider network.
